(19) United States
(12) Patent Application Publication
(10) Pub. No.: US 2006/0208575 A1
(43) Pub. Date: Sep. 21, 2006

(54) MULTILAYER CERAMIC CAPACITOR AND PROCESS FOR PRODUCING SAME

(76) Inventors: Hirokazu Orimo, Haruna-Machi, Gunma-Gun, Gunma (JP); Noriyuki Chigira, Haruna-Machi, Gunma-Gun, Gunma (JP); Chie Kawumara, Haruna-Machi, Gunma-Gun, Gunma (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/383,114

(22) Filed: May 12, 2006

(30) Foreign Application Priority Data
May 13, 2005 (JP) 2005-141591

(51) Int. Cl. H02M 3/06

(52) U.S. Cl. 307/109

(57) ABSTRACT

Diffusion-phase grain layer formed of diffusion-phase grains (first grains G1 and second grains G2) arranged in the form of a layer is present between a dielectric layer and an internal electrode layer. Thus, even if oxygen vacancies formed in third grains G3 constituting the dielectric layer move toward the interface between the dielectric layer and the internal electrode layer to accumulate in the third grains G3 present in the vicinity of the interface, the presence of the diffusion-phase grain layer prevents a current from concentrating in a portion having a reduced resistance due to the oxygen vacancies to suppress insulation degradation that can be formed in the multilayer ceramic capacitor.

### BACKGROUND OF THE INVENTION

1. Field of the Invention

The present invention relates to a multilayer ceramic capacitor having a laminated structure with alternating dielectric layers and internal electrode layers. The present invention also relates to a process for producing the multilayer ceramic capacitor.

2. Description of the Related Art

Multilayer ceramic capacitors each includes a ceramic chip and a pair of external electrodes, the ceramic chip having a structure with alternating dielectric layers and internal electrode layers, ends of the internal electrode layers being alternately exposed at opposite faces of the ceramic chip, the external electrodes being disposed on the respective faces at which the ends of the internal electrode layers are exposed, and the ends of the internal electrode layers exposed at one of the faces being electrically connected to the corresponding external electrode.

Such a multilayer ceramic capacitor has been required to have a higher capacitance and a smaller size. To achieve an increase in the dielectric constant of each dielectric layer and a reduction in the rate of change of dielectric constant with temperature, each dielectric layer is formed of grains each having a core-shell structure.

For example, Japanese Unexamined Patent Application Publication No. 2004-111951 discloses a method for forming grains each having a core-shell structure containing a core composed of BaTiO₃ and a shell containing additives, such as Mg and a rare-earth element, diffused in BaTiO₃, the method including forming a dielectric green layer from a ceramic slurry containing at least a BaTiO₃ powder, a Mg compound powder, and a rare-earth compound powder and diffusing the additives, such as Mg and the rare-earth element, into the surface of the core composed of BaTiO₃ during firing the dielectric green layer to form the shell.

Thus, each grain having a large core has a small shell thickness; hence, such a grain has a high dielectric constant. In other words, each grain having a small core has a large shell thickness; hence, such a grain has low dielectric constants but satisfactory temperature characteristics. That is, the coexistence of the grains having high dielectric constants and the grains having low dielectric constants but having the satisfactory temperature characteristics results in the dielectric layer with a high dielectric constant and a low rate of change of dielectric constant with temperature.

By the way, insulation degradation (dielectric breakdown) that can be formed in the multilayer ceramic capacitor is believed to be caused by the following mechanism: Oxygen vacancies formed in the grains constituting the dielectric layer move toward the interface between the dielectric layer and the internal electrode layer and accumulate in the grains present in the vicinity of the interface. Then, a current concentrates in a portion having a reduced resistance due to the oxygen vacancies. The insulation degradation significantly affects the life of the multilayer ceramic capacitor. Therefore, to provide a multilayer ceramic capacitor that reliably exhibits initial properties for a long period, it is necessary to prevent the insulation degradation.

The dielectric layer includes grains each having only a core without a shell and grains each having only a shell without a core in addition to the grains having the core-shell structures with different shell thicknesses. If the grains each having the core-shell structure with a large shell thickness and the grains each having only the shell without the core are disposed at the interface between the dielectric layer and the internal electrode layer, it is possible to suppress the insulation degradation. However, these various types of grains are randomly disposed in the dielectric layer. Thus, even when the dielectric layer is formed of the grains each having the core-shell structure, it is difficult to suppress the insulation degradation.

### SUMMARY OF THE INVENTION

The present invention was accomplished in consideration of the above-described situation. It is an object of at least one embodiment of the present invention to provide a multilayer ceramic capacitor that suppresses insulation degradation and has an improved life property, and a process for suitably producing the multilayer ceramic capacitor.

To achieve the object, an inventive multilayer ceramic capacitor having a laminated structure with alternating dielectric layers and internal electrode layers includes a diffusion-phase grain layer containing diffusion-phase grains, the diffusion-phase grains being arranged in the form of a layer, and the diffusion-phase grain layer being disposed between the dielectric layer and the internal electrode layer.

According to the multilayer ceramic capacitor, the diffusion-phase grain layer formed of the diffusion-phase grains arranged in the form of a layer is present between the dielectric layer and the internal electrode layer. Thus, even if oxygen vacancies formed in grains constituting the dielectric layer move toward the interface between the dielectric layer and the internal electrode layer to accumulate in grains present in the vicinity of the interface, the presence of the diffusion-phase grain layer prevents a current from concentrating in a portion having a reduced resistance due to the oxygen vacancies to suppress insulation degradation that can be formed in the multilayer ceramic capacitor. Therefore, the multilayer ceramic capacitor has a significantly improved life property and reliably exhibits initial properties for a long period.

A process according to the present invention for producing a multilayer ceramic capacitor having a laminated structure with alternating dielectric layers and internal electrode layers, includes the steps of forming a ceramic slurry containing at least a dielectric powder and applying and drying the resulting ceramic slurry to form dielectric green layers each having a predetermined thickness; forming a conductive paste for forming the internal electrode layer, the conductive paste containing at least a diffusion-phase powder, and applying the conductive paste to a surface of each dielectric green layer by printing to form a green internal electrode layer; laminating the dielectric green layers each having the green internal electrode layer to form a green ceramic chip; and firing the green ceramic chip at a predetermined temperature.

According to the process for producing the multilayer ceramic capacitor, the multilayer ceramic capacitor can be produced suitably and reliably.

The object, other objects, the structure, and advantages of the present invention will be apparent from the descriptions below and the drawings to which they refer.

### BRIEF DESCRIPTION OF THE DRAWINGS

The drawings are intended to illustrate and not to limit the invention and are oversimplified for illustrative purposes and are not to scale.

FIG. 1 is a partially cutout isometric view of a multilayer ceramic capacitor according to an embodiment of the present invention; and

FIG. 2 shows a layer structure, grain structures in diffusion-phase grain layers, and grain structures in a dielectric layer in the ceramic chip shown in FIG. 1.

### DESCRIPTION OF THE PREFERRED EMBODIMENTS

The present invention will be explained with respect to preferred embodiments and drawings. However, the preferred embodiments and drawings are not intended to limit the present invention.

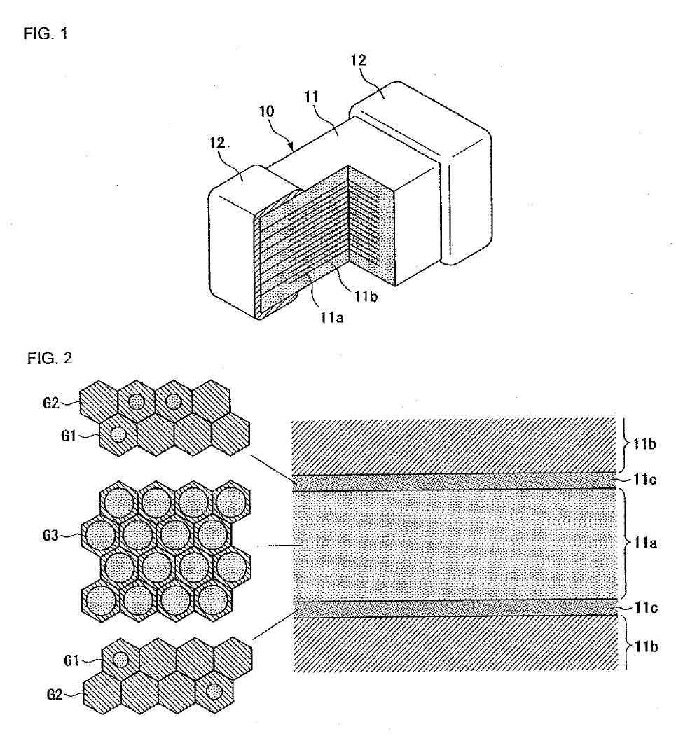

FIG. 1 is a partially cutout isometric view of a multilayer ceramic capacitor according to an embodiment of the present invention. FIG. 2 shows a layer structure, grain structures in diffusion-phase grain layers, and grain structures in a dielectric layer in the ceramic chip shown in FIG. 1.

The multilayer ceramic capacitor 10 shown in FIG. 1 includes a ceramic chip 11 having a rectangular parallelepiped shape; and external electrodes 12 disposed at both ends of the ceramic chip 11 in the longitudinal direction.

The ceramic chip 11 has a laminated structure with alternating dielectric layers ilia each composed of a dielectric material and internal electrode layers 11b each composed of a base metal. Ends of the internal electrode layers 11b are alternately exposed at opposite faces of the ceramic chip 11, i.e., ends of the internal electrode layers lib are alternately exposed at end faces of the ceramic chip 11 in the longitudinal direction. The external electrodes 12 each have a multilayer structure composed of a base material. The innermost layer of each external electrode 12 is electrically connected to the exposed ends of the internal electrode layers 11b.

As shown in FIG. 2, diffusion-phase grain layers 11c are each formed of diffusion-phase grains arranged in the form of a layer and are each present between the dielectric layer 11a and the internal electrode layer 11b. For the sake of convenience, boundary lines are each expressed as a straight line in the figure. However, actual boundary lines are nonlinear, and the boundaries are not so clear.

The diffusion-phase grain layers 11c each include first grains G0 and second grains G2, the first grains G1 each having a core-shell structure containing a core mainly composed of a dielectric and a shell containing a metal element diffused in the dielectric, and the second grains G2 each having a non-core-shell structure consisting of only a shell containing a metal element diffused in the dielectric. Of course, each of the diffusion-phase grain layers 11c may consist of the first grains G1 alone or the second grains G2 alone.

The core of each first grain G1 is mainly composed of a dielectric such as BaTiO₃. The second grains G2 and the shells of the first grains G1 each contain at least one metal element selected from Mg, Ca, Sr, Mn, Zr, V, Nb, Cr, Fe, Co, Ni, Y, La, Eu, Gd, Tb, Dy, Ho, Er, Tm, and Yb.

The dielectric layer 11a is formed of third grains G3 each having a core-shell structure containing a core mainly composed of a dielectric and a shell containing a metal element diffused in the dielectric. The dielectric layer 11a further contains grains each having only a core without a shell (not shown) and grains each having only a shell without a core (not shown) in addition to the grains having the core-shell structures with different shell thicknesses.

The core of each third grain G3 is mainly composed of the dielectric such as BaTiO₃. The shell of each third grain G3 contains at least one metal element selected from Mg, Ca, Sr, Mn, Zr, V, Nb, Cr, Fe, Co, Ni, Y, La, Eu, Gd, Tb, Dy, Ho, Er, Tm, and Yb.

The internal electrode layers 11b and the external electrodes 12 are each composed of a base metal, such as Ni, Cu, or Sn, as a main component.

The multilayer ceramic capacitor 10 is produced by a process including the steps of forming a ceramic slurry containing at least a dielectric powder such as BaTiO₃ and a diffusion-phase powder and applying and drying the resulting ceramic slurry to form a dielectric green layer having a predetermined thickness; forming a conductive paste for forming the internal electrode layer, the conductive paste containing at least a powdery base metal, such as Ni, Cu, or Sn, and a diffusion-phase powder, and applying the conductive paste to a surface of the dielectric green layer by printing to form an internal electrode green layer; laminating the dielectric green layers each having the internal electrode green layer to form a green ceramic chip; applying a conductive paste for forming an external electrode to end faces of the green ceramic chip in the longitudinal direction to form green external electrodes, the conductive paste containing at least a powdery base metal, such as Ni, Cu, or Sn; and firing the green ceramic chip having the green external electrodes at a predetermined temperature.

The diffusion-phase powder in the conductive paste for forming the internal electrode layer is composed of an oxide containing at least one metal element selected from Mg, Ca, Sr, Mn, Zr, V, Nb, Cr, Fe, Co, Ni, Y, La, Eu, Gd, Tb, Dy, Ho, Er, Tm, and Yb.

The step of forming the green external electrodes may be performed after the step of firing the green ceramic chip. That is, after the conductive paste for forming the external electrode is applied to the fired ceramic chip to form the green external electrodes, the resulting green external electrodes may be fired. Furthermore, according to need, the fired ceramic chip may be subjected to reoxidation.

According to the multilayer ceramic capacitor 10, the diffusion-phase grain layers 11c each formed of the diffusion-phase grains (the first grains G0 and the second grains G2) arranged in the form of a layer are each present between the dielectric layer 11a and the internal electrode layer 11b. Thus, even if oxygen vacancies formed in the third grains G3 constituting the dielectric layer 11a move toward the interface between the dielectric layer 11a and the internal electrode layer 11b to accumulate in the third grains G3 present in the vicinity of the interface, the presence of the diffusion-phase grain layers 11c prevents a current from concentrating in a portion having a reduced resistance due to the oxygen vacancies to suppress insulation degradation that can be formed in the multilayer ceramic capacitor. Therefore, the multilayer ceramic capacitor 10 has a significantly improved life property and reliably exhibits initial properties for a long period.

According to the process for producing the multilayer ceramic capacitor 10, the multilayer ceramic capacitor 10 can be produced suitably and reliably. The diffusion-phase grain layers 11c are believed to be formed by the following mechanism: Firing the green internal electrode layer results in the formation of the first grains G1 and the second grains G2, the first grains G1 each having the core-shell structure including the core mainly composed of the dielectric and the shell in which the metal element in the diffusion-phase powder is diffused in the dielectric, and the second grains G2 each having the non-core-shell structure consisting of only the shell in which the metal element in the diffusion-phase powder is diffused in the dielectric. Then, the crystallization of the powdery base metal in the green internal electrode layer causes the transfer of the first grains G1 and the second grains G2 toward the dielectric layer 11a; hence, the first grains G1 and the second grains G2 are arranged in the form of a layer.

The formation of the diffusion-phase grain layer 11c suppresses the diffusion of the metal element from the green interlayer electrode layer to the dielectric green layer during the firing step, thereby preventing a reduction in the dielectric constant of the dielectric layer 11a due to an increase in the thickness of the shell of each third grain G3 constituting the dielectric layer 11a, the third grain G3 having the core-shell structure. In particular, the formation of the diffusion-phase grain layer 11c effectively improves the dielectric constant and the life property of the multilayer ceramic capacitor including the dielectric layer 11a having a small number of grains in the thickness direction.

An exemplary process for producing the multilayer ceramic capacitor will be described below. In the present disclosure where conditions and/or structures are not specified, the skilled artisan in the art can readily provide such conditions and/or structures, in view of the present disclosure, as a matter of routine experimentation.

### PRODUCTION EXAMPLE 1

A BaTiO₃ powder, 1 mol of powdery Ho₂O₃, 0.5 mol of powdery MgO, 0.1 mol of powdery Mn₂O₃, and 1.5 mol of powdery SiO₂, with respect to 100 mol of BaTiO₃, were wet-mixed and pulverized with a ball mill. The resulting mixture was dried in a high-temperature dryer. The dried mixture was calcined at 800° C. in air to form a calcined powder. The resulting calcined powder, 10 parts by weight of an organic binder (polyvinyl butyral) with respect to the weight of the calcined powder, and an organic solvent having the same weight as that of the calcined powder, the solvent being mainly composed of ethanol, were mixed with a ball mill to form a ceramic slurry.

A Ni powder, 10 parts by weight of a diffusion-phase powder composed of (Ba₁₋₂ₓHo₂ₓ) (Ti₁₋ₓMnₓ)O₃ (wherein x is 0.015), 10 parts by weight of a cellulose-based binder, with respect to the weight of the Ni powder, and an organic solvent having the same weight as that of the Ni powder, the solvent being mainly composed of terpineol, were mixed with a ball mill to form a conductive paste for forming the internal electrode layer.

The ceramic slurry was applied to a surface of a film composed of polyethylene terephthalate (PET) or the like to form a slurry layer having a predetermined thickness. The resulting slurry layer was dried to form a dielectric green layer having a thickness of about 5 μm.

The conductive paste was applied in predetermined shape and pattern to a surface of the dielectric green layer by printing to form a green internal electrode layer having a thickness of about 1.5 μm. The dielectric green layer had a size such that the dielectric green layer could be separated into a plurality of pieces. The green internal electrode layers were arrayed in a matrix on the dielectric green layer, the number of the green internal electrode layers corresponding to the number of the pieces of the dielectric green layer.

The dielectric green layers each having the green internal electrode layer were laminated such that ten green internal electrode layers were laminated. The resulting laminate was subjected to thermocompression bonding and cut at predetermined positions into green ceramic chips each having a predetermined size. Ends of the green internal electrode layers were alternately exposed at opposite faces of each green ceramic chip, i.e., ends of the green internal electrode layers were alternately exposed at end faces of each green ceramic chip in the longitudinal direction.

The conductive paste for forming the external electrode, the conductive paste containing a Ni powder, an organic binder, and the like, was applied to end faces of each green ceramic chip in the longitudinal direction by dipping to form green external electrodes.

The green ceramic chips each having the green external electrodes were debindered in a N₂ atmosphere and then fired at 1,300° C. and an oxygen partial pressure of 10⁻⁵ to 10⁻⁸ atm (about 1 to 10⁻³ Pa) That is, the green ceramic chips each having the green internal electrode layers and the green external electrodes were simultaneously fired.

The fired ceramic chip was subjected to reoxidation at 800° C. to 1,000° C. in a N₂ atmosphere to produce a multilayer ceramic capacitor shown in FIG. 1.

### PRODUCTION EXAMPLE 2

A multilayer ceramic capacitor shown in FIG. 1 was produced as in PRODUCTION EXAMPLE 1, except that the conductive paste for forming the internal electrode layer contained 20 parts by weight of the diffusion-phase powder.

### COMPARATIVE EXAMPLE

A multilayer ceramic capacitor shown in FIG. 1 was produced as in PRODUCTION EXAMPLE 1, except that the conductive paste for forming the internal electrode layer contained no diffusion-phase powder.

### EVALUATION RESULTS OF PRODUCTION EXAMPLES 1 AND 2 AND COMPARATIVE EXAMPLE

The multilayer ceramic capacitors produced in PRODUCTION EXAMPLES 1 and 2 and COMPARATIVE EXAMPLE were each cut in the stacking direction. After polishing the cut surface of each capacitor, the concentration distribution of Ho and Mn on each cut surface was measured with an electron probe microanalyzer (EPMA). It was confirmed that each of the multilayer ceramic capacitors produced in PRODUCTION EXAMPLES 1 and 2 contained high concentrations of Ho and Mn between the dielectric layer and the internal electrode layer. In contrast, it was confirmed that the multilayer ceramic capacitor produced in COMPARATIVE EXAMPLE had no portion where high concentrations of Ho and Mn were present between the dielectric layer and the internal electrode layer.

Furthermore, the distribution of the grains on each cut surface was observed with a transmission electron microscope (TEM). It was confirmed that the multilayer ceramic capacitors produced in PRODUCTION EXAMPLES 1 and 2 each contain grains corresponding to the first grains G1 and grains corresponding to the second grains G2 shown in FIG. 2 between the dielectric layer and the internal electrode layer. In contrast, it was confirmed that the multilayer ceramic capacitor produced in COMPARATIVE EXAMPLE did not contain the grains corresponding to the first grains G1 and the grains corresponding to the second grains G2 shown in FIG. 2 between the dielectric layer and the internal electrode layer.

That is, it was clear that the multilayer ceramic capacitors produced in PRODUCTION EXAMPLES 1 and 2 each contained layers corresponding to the diffusion-phase grain layers 11c shown in FIG. 2, each of the layers being disposed between the dielectric layer and the internal electrode layer.

Furthermore, to measure lifetimes of the multilayer ceramic capacitors produced in PRODUCTION EXAMPLES 1 and 2 and COMPARATIVE EXAMPLE, the capacitors were each subjected to a high-temperature accelerated life test under accelerated conditions (150° C., 20 V/μm). As a result, it was confirmed that the multilayer ceramic capacitors produced in PRODUCTION EXAMPLES 1 and 2 had average lifetimes of 8,000 seconds and 14,000 seconds, respectively (in other examples, 5,000 to 20,000 seconds). On the other hand, it was confirmed that the multilayer ceramic capacitor produced in COMPARATIVE EXAMPLE had an average lifetime of 1,000 seconds.

The values used in the above examples can vary by 10%-50% without significant changes in operation and in the results.

The present application claims priority to Japanese Patent Application No. 2005-14159, filed May 3, 2005, the disclosure of which is incorporated herein by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A multilayer ceramic capacitor including a laminated structure with alternating dielectric layers and internal electrode layers, comprising:
a diffusion-phase grain layer including diffusion-phase grains, the diffusion-phase grains being arranged in the form of a layer, and the diffusion-phase grain layer being disposed between the dielectric layer and the internal electrode layer.

2. The multilayer ceramic capacitor according to claim 1, wherein the diffusion-phase grain layer includes at least one of first grains and second grains, the first grains each having a core-shell structure containing a core mainly composed of a dielectric and a shell containing a metal element diffused in the dielectric, and the second grains each having a non-core-shell structure consisting of only a shell containing a metal element diffused in a dielectric.

3. The multilayer ceramic capacitor according to claim 2, wherein the second grains and the shells of the first grains each contain at least one metal element selected from Mg, Ca, Sr, Mn, Zr, V, Nb, Cr, Fe, Co, Ni, Y, La, Eu, Gd, Tb, Dy, Ho, Er, Tm, and Yb.

4. A process for producing a multilayer ceramic capacitor including a laminated structure with alternating dielectric layers and internal electrode layers, the process comprising the steps of:
forming a ceramic slurry containing at least a dielectric powder and applying and drying the resulting ceramic slurry to form dielectric green layers each having a predetermined thickness;
forming a conductive paste for forming the internal electrode layer, the conductive paste containing at least a diffusion-phase powder, and applying the conductive paste to a surface of each dielectric green layer by printing to form a green internal electrode layer;
laminating the dielectric green layers each having the green internal electrode layer to form a green ceramic chip; and
firing the green ceramic chip at a predetermined temperature.

5. The process for producing the multilayer ceramic capacitor according to claim 4, wherein the diffusion-phase powder contains an oxide containing at least one metal element selected from Mg, Ca, Sr, Mn, Zr, V, Nb, Cr, Fe, Co, Ni, Y, La, Eu, Gd, Tb, Dy, Ho, Er, Tm, and Yb.

6. A multilayer ceramic capacitor comprising a ceramic chip which comprises:
a laminated structure with alternating dielectric layers and internal electrode layers; and
diffusion-phase grain layers each disposed between each dielectric layer and each internal electrode layer, each diffusion-phase grain layer including diffusion-phase grains arranged in layers configured to inhibit a current from concentrating in a portion having a reduced resistance due to oxygen vacancies formed in the dielectric layer and moving toward the electrode layer.

7. The multilayer ceramic capacitor according to claim 6, wherein the diffusion-phase grain layer comprises first grains and second grains, the first grains each having a core-shell structure containing a core mainly composed of a dielectric and a shell containing a metal element diffused in the dielectric, and the second grains each having a non-core-shell structure consisting of only a shell containing a metal element diffused in a dielectric.

8. The multilayer ceramic capacitor according to claim 7, wherein the second grains and the shells of the first grains each contain at least one metal element selected from the group consisting of Mg, Ca, Sr, Mn, Zr, V, Nb, Cr, Fe, Co, Ni, Y, La, Eu, Gd, Tb, Dy, Ho, Er, Tm, and Yb.

9. The multilayer ceramic capacitor according to claim 6, wherein ends of the internal electrode layers are alternately exposed at end faces of the ceramic chip in its longitudinal direction.

10. The multilayer ceramic capacitor according to claim 9, further comprising external electrodes each have a multilayer structure composed of a base material, wherein the innermost layer of each external electrode is electrically connected to the exposed ends of the internal electrode layers.

11. The multilayer ceramic capacitor according to claim 7, wherein each dielectric layer is formed of third grains each having a core-shell structure containing a core mainly composed of a dielectric and a shell containing a metal element diffused in the dielectric.

12. The multilayer ceramic capacitor according to claim 6, which has an average lifetime of 5,000 seconds or longer as measured by a high-temperature accelerated life test under accelerated conditions at 150° C. at 20 V/μm.

13. A method of producing a multilayer ceramic capacitor including a laminated structure with alternating dielectric layers and internal electrode layers, said method comprising the steps of:
forming a ceramic slurry containing at least a dielectric powder;
applying and drying the resulting ceramic slurry, thereby forming dielectric green layers each having a predetermined thickness;
forming a conductive paste for forming the internal electrode layer, the conductive paste containing at least a diffusion-phase powder;
applying the conductive paste to a surface of each dielectric green layer by printing, thereby forming a green internal electrode layer;
laminating the dielectric green layers each having the green internal electrode layer, thereby forming a green ceramic chip; and
sintering the green ceramic chip at a predetermined temperature.

14. The method according to claim 13, wherein the step of forming a conductive paste comprises selecting as the diffusion-phase powder an oxide powder containing at least one metal element selected from the group consisting of Mg, Ca, Sr, Mn, Zr, V, Nb, Cr, Fe, Co, Ni, Y, La, Eu, Gd, Tb, Dy, Ho, Er, Tm, and Yb.
